(19) United States
(12) Patent Application Publication
(10) Pub. No.: US 2007/0288959 A1
(43) Pub. Date: Dec. 13, 2007

(54) SINGLE-BUTTON REMOTE ACCESS TO A SYNTHETIC CHANNEL PAGE OF SPECIALIZED CONTENT

(75) Inventors: Anthony F. Istvan, Snoqualmie, WA (US); Paul G. Allen, Mercer Island, WA (US)

Correspondence Address: DIGEO, INC C/O STOEL RIVES LLP, 201 SOUTH MAIN STREET, SUITE 1100, ONE UTAH CENTER, SALT LAKE CITY, UT, 84111, US

(73) Assignee: Digeo, Inc., Kirkland, WA (US)

(21) Appl. No.: 11/836,975

(22) Filed: Aug. 10, 2007

Related U.S. Application Data
(63) Continuation of application No. 09/788,997, filed on Feb. 16, 2001.
Application No. 09/788,997 is a continuation-in-part of application No. 09/624,198, filed on Jul. 24, 2000, now abandoned.
Application No. 09/624,198 is a continuation-in-part of application No. 09/591,547, filed on Jun. 8, 2000, now abandoned.
(60) Provisional application No. 60/193,046, filed on Mar. 29, 2000.

(51) Int. Cl. G06F 13/00

(52) U.S. Cl. 725/39

(57) ABSTRACT

A method of displaying multimedia content on a display area of a broadband Internet-enabled television system includes providing a remote control to control contents being displayed on the display area. A television content is displayed on the display area. A first instruction transmitted by the remote control in response to activation of a first button is received. A first synthetic channel page is displayed in response to the first instruction. The first synthetic channel page includes a television content section and an Internet content section.

### RELATED APPLICATIONS

The present application is a continuation of U.S. patent application Ser. No. 09/788,997, entitled “Single-Button Remote Access to a Synthetic Channel Page of Specialized Content,” filed Feb. 16, 2001, with inventors Anthony F. Istvan and Paul G. Allen. U.S. patent application Ser. No. 09/788,997 is related to and claims priority from U.S. Provisional Patent Application Ser. No. 60/258,134, entitled “Single-Button Remote Access to a Synthetic Channel Page of Specialized Content,” filed Dec. 22, 2000, with inventors Anthony F. Istvan and Paul G. Allen, and U.S. Provisional Patent Application Ser. No. 60/193,046, entitled “User Interface for Interactive Television with Broadband Connectivity to the Internet,” filed Mar. 29, 2000, with inventor Anthony F. Istvan. U.S. patent application Ser. No. 09/788,997 is also a continuation-in-part of U.S. patent application Ser. No. 09/624,198, entitled “User Customizable Interface to TV and Internet Content,” filed Jul. 24, 2000, with inventor Anthony F. Istvan, which is in turn a continuation-in-part of U.S. patent application Ser. No. 09/591,547, entitled “L Configured User Interface to Television and Internet Content,” filed Jun. 8, 2000, with inventors Anthony F. Istvan and Lisa M. Wilkins. Each of the above-listed patent applications are hereby incorporated by reference herein in their entirety.

### COPYRIGHT NOTICE

A portion of the disclosure of this patent document contains material which is subject to copyright protection. The copyright owner has no objection to the xerographic reproduction by anyone of the patent document or the patent disclosure in exactly the form it appears in the Patent and Trademark Office patent file or records, but otherwise reserves all copyright rights whatsoever.

### FIELD OF THE INVENTION

The present application pertains to the fields of television reception and Internet access. More particularly, the present application pertains to a user interface to television broadcasts and Internet content.

### BACKGROUND

Televisions and Internet technologies are beginning to converge. In particular, access to the World Wide Web via an Internet-enabled television system is progressing and becoming more popular. However, prior art user interfaces for such systems are limited in their capabilities and do not provide for user-friendly access to both broadcast television (TV) and Internet content.

U.S. Pat. No. 6,034,689, entitled “Web Browser Allowing Navigation Between Hypertext Objects Using Remote Control,” discloses browser software implemented in a set-top box which allows a user to navigate using a remote control through World Wide Web pages. This browser software has limited capabilities and comprises a relatively simple user interface which allows for selection of hypertext anchors. In this simple user interface, access to Web pages is provided for separately from access to broadcast TV.

### SUMMARY

User interfaces for Internet-enabled television systems have unique needs stemming from their need to display, in a user-friendly way, both broadcast television and Internet content. The present invention provides for user-friendly access to both broadcast television and Internet content via a single integrated user interface.

In one embodiment, a method of displaying multimedia content on a display area of a broadband Internet-enabled television system includes providing a remote control to control contents being displayed on the display area. A television content is displayed on the display area. A first instruction transmitted by the remote control in response to activation of a first button is received. A first synthetic channel page is displayed in response to the first instruction. The first synthetic channel page includes a television content section and an Internet content section.

### BRIEF DESCRIPTION OF THE DRAWINGS

FIG. 1 is a schematic diagram depicting a system 100 for distributing Internet content, in addition to TV content, in accordance with an embodiment of the present invention.

FIG. 2 is an illustrative screen frame of a display with a full-size video being displayed.

FIG. 3 depicts an example layout 300 of a user interface (UI) which has been activated in accordance with an embodiment of the present invention.

FIG. 4 is an illustrative screen frame of a UI which has been activated in accordance with an embodiment of the present invention.

FIG. 5 depicts an example layout 500 of a UI with a user submenu activated in accordance with an embodiment of the present invention.

FIG. 6 depicts an example layout 600 of a UI with a TV submenu 602 activated in accordance with an embodiment of the present invention.

FIG. 7 depicts an example layout 700 of a UI with television listing controls in the context-sensitive area 304 in accordance with an embodiment of the present invention.

FIG. 8 is an illustrative screen frame of a UI in a TV listing mode which provides an electronic programming guide (EPG) in accordance with an embodiment of the present invention.

FIG. 9 depicts an example layout 900 of a UI with a browser submenu 902 activated in accordance with an embodiment of the present invention.

FIG. 10 depicts an example layout 1000 of a UI with browser controls in the context-sensitive area 304 in accordance with an embodiment of the present invention.

FIG. 11 is an illustrative design for a remote control 1100 in accordance with an embodiment of the present invention.

FIG. 12 depicts a synthetic channel settings page 1200 for user customization of selections of synthetic channels focusing on specialized content categories in accordance with an embodiment of the present invention.

FIG. 13 depicts an example page of a synthetic channel focusing on general news for purposes of illustration.

FIG. 14 depicts an example page of a synthetic channel focusing on sports news for purposes of illustration.

FIG. 15 depicts an example page of a synthetic channel focusing on financial news for purposes of illustration.

FIG. 16 depicts an example page of a synthetic channel focusing on entertainment news for purposes of illustration.

FIG. 17 depicts an example page of synthetic channel focusing on football for purposes of illustration.

FIG. 18 depicts a user interface which includes a multimedia bar and an embedded media viewer in accordance with an embodiment of the present invention.

FIG. 19 depicts a user interface which includes a multimedia bar for use with pop-up media viewers in accordance with an embodiment of the present invention.

FIG. 20 depicts a pop-up media viewer overlaid over a screen in accordance with an embodiment of the present invention.

FIG. 21A depicts a pop-up text viewer overlaid over a screen in accordance with an embodiment of the present invention.

FIG. 21B illustrates a method of navigating from a television mode to a “Sports Channel” mode in an interactive television system provided by AOLTV.

FIG. 22 is an illustrative design for a remote control in accordance with an embodiment of the present invention.

FIGS. 23-25 are illustrative methods of navigating between a television content and a synthetic sports channel page in accordance with embodiments of the present invention.

### DESCRIPTION OF THE SPECIFIC EMBODIMENTS

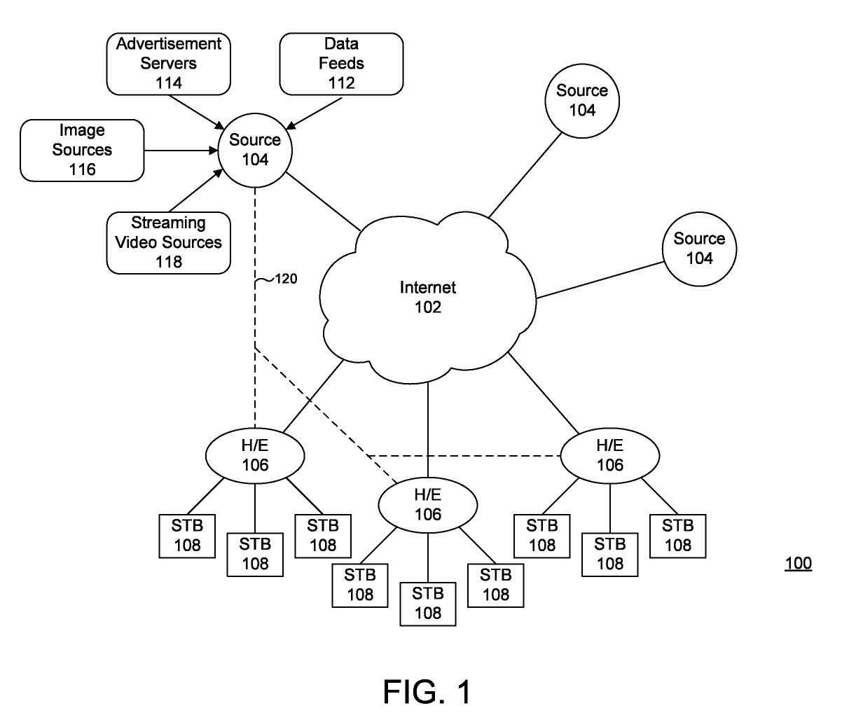

FIG. 1 is a schematic diagram depicting a system 100 for distributing Internet content, in addition to TV content, in accordance with an embodiment of the present invention. In accordance with an embodiment of the present invention, the system 100 is integrated with a cable TV distribution system. Such cable TV distribution systems may include cable headends and are well known in the art.

The system 100 includes an Internet 102, a plurality of content sources 104, a plurality of distribution centers (depicted as headends or H/E) 106, and a plurality of client terminals (depicted as set top boxes or STB) 108. In addition, a content source 104 is depicted as receiving data from data feeds 112, advertisement servers 114, image sources 116, and streaming video sources 118.

The plurality of content sources 104 are coupled to the Internet 102. For example, a content source 104 may comprise a web site portal such as Go2Net.com, or a news web site such as CNN.com, or other types of sources. Each content source 104 may have various data feeds 112, servers 114, and sources 116/118 coupled to it.

For example, news or stock quote feeds 112 may be fed into the content source 104. Servers 114 may provide advertisements for insertion into multimedia content delivered by the content source 104. Sources 116/118 may provide images 116, streaming video 118, and other content to the content source 104. Various other feeds, servers and sources may also be coupled to the content source 104.

The Internet 102 comprises a network of networks and is well known in the art. Communications over the Internet 102 are accomplished using standard protocols such as TCP/IP (transmission control protocol/internet protocol) and other protocols. The Internet 102 is coupled to the plurality of distribution centers 106. For example, a distribution center 106 may comprise a cable headend (H/E).

Each distribution center 106 is coupled to a plurality of client terminals 108. For example, a client terminal 108 may comprise a set top box (STB), a personal computer, an interactive television set, or another type of communication device.

In alternative or in addition to the Internet 102 being used to distribute multimedia content from the content sources 104 to distribution centers 106, communications channels or networks 120 apart from the Internet 102 may couple one or more content source 104 to one or more distribution center 106. One example of such an alternate path for communications is illustrated in FIG. 1. Other configurations are also possible and meant to be included within the scope of the present invention.

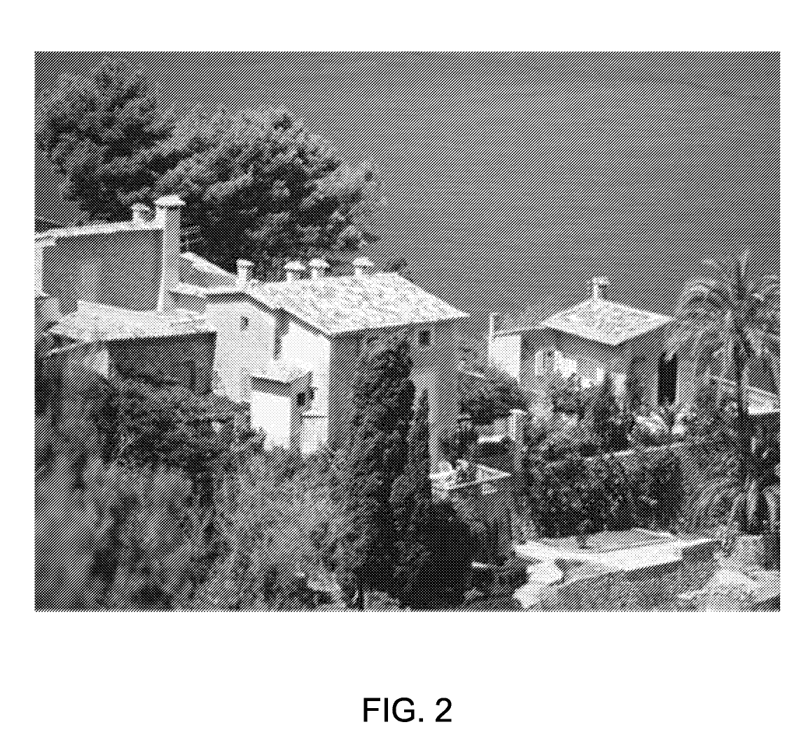

FIG. 2 is an illustrative screen frame of a display with a full-size video being displayed. While the screen frame is a still frame, the actual video is a motion video comprising a multitude of frames in sequence.

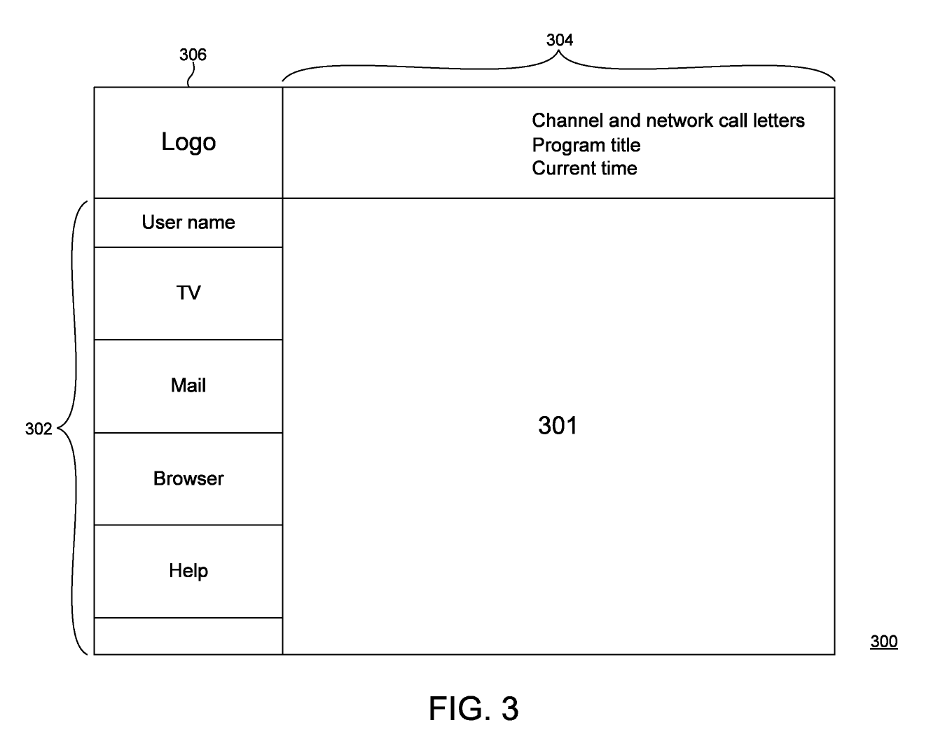

FIG. 3 depicts an example layout 300 of a user interface (UI) which has been activated in accordance with an embodiment of the present invention. In one embodiment, when the UI is activated, the full-size display (see FIG. 2) shrinks in an “animated” fashion (i.e. with visible motion to a viewer) to occupy a reduced-size area 301 of the display. Alternatively, when the UI is activated, the L configured UI may be superimposed (overlaid) over the full-size display. For example, shrinking the full-size display may be used if the display is showing TV or video content, while superimposing over the full-size display may be used if the display is showing pages which do not scale well. A “menu” button on a remote control unit may be used to activate and deactivate the UI.

The UI includes a group of primary or “permanent” controls 302 on a first side of the reduced-size area 301, a context-sensitive area 304 on a second side of the reduced-size area 301 (perpendicular to the first side), and a logo area 306 at the intersection of the two sides. In the example layout 300 shown in FIG. 3, the primary controls 302 include user (“user name”), TV, mail, browser, and help controls or control icons.

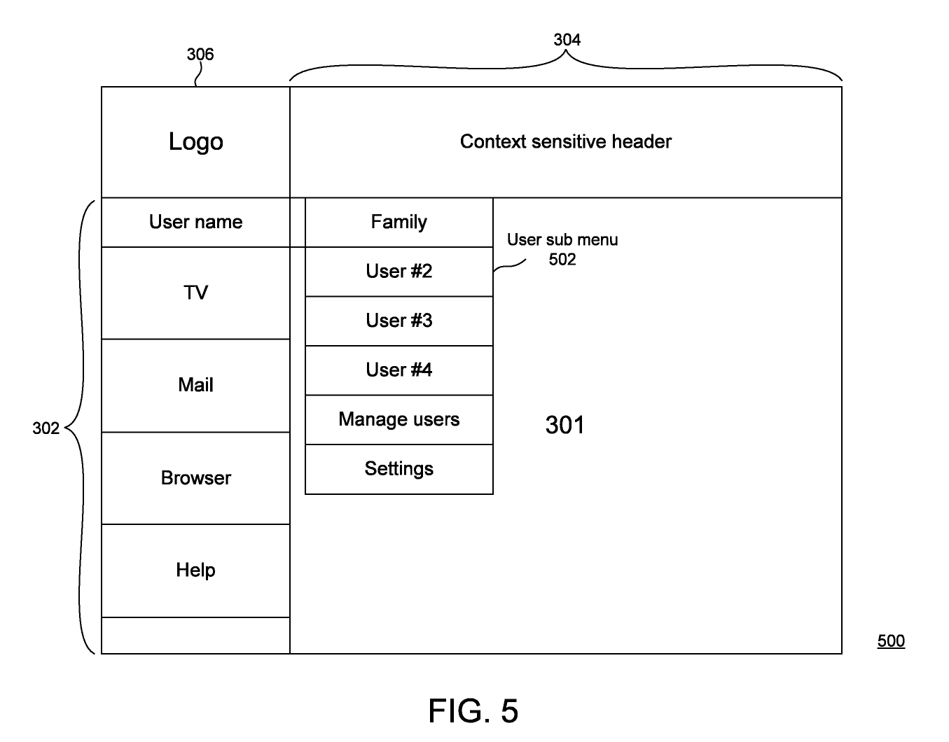

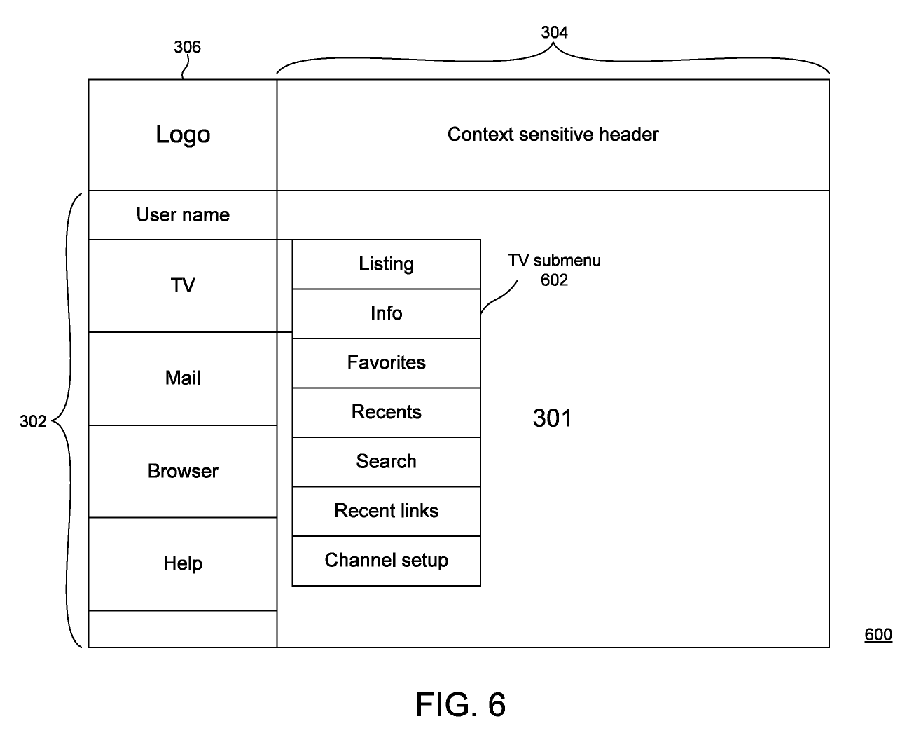

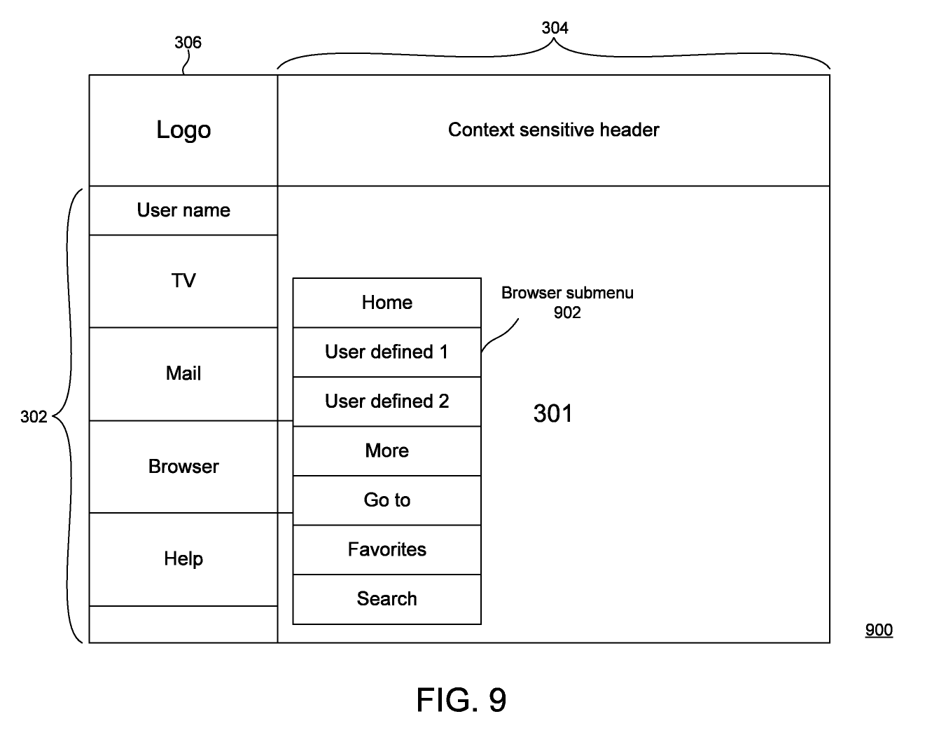

Selection of these primary control icons typically reveals a corresponding submenu. For purposes of illustration, described in detail below are a selection of such submenus. First, an example of a user submenu 502 is described below in relation to FIG. 5. Second, an example of the TV submenu 602 is described below in relation to FIG. 6. Third, an example of a browser submenu 902 is described below in relation to FIG. 9.

The context-sensitive area 304 may display different information (non-selectable items) and control icons (selectable items) depending upon the content in the display area 301. Initially, the context-sensitive area 304 may display information on the TV content currently being displayed in the display area 301. The information may include, for example, channel number/network call letters, program title, and current time.

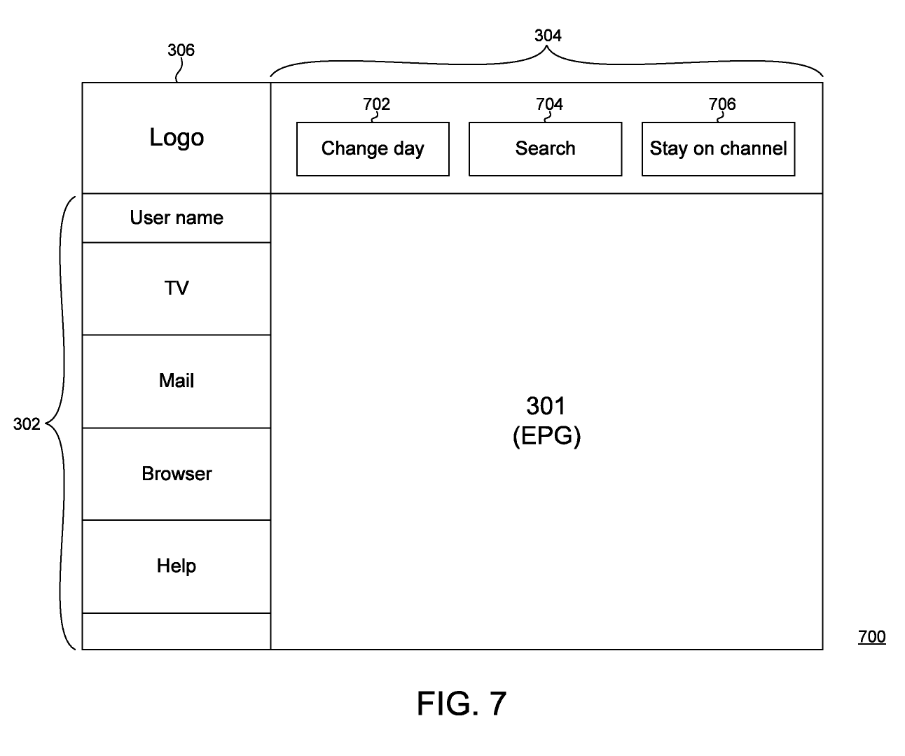

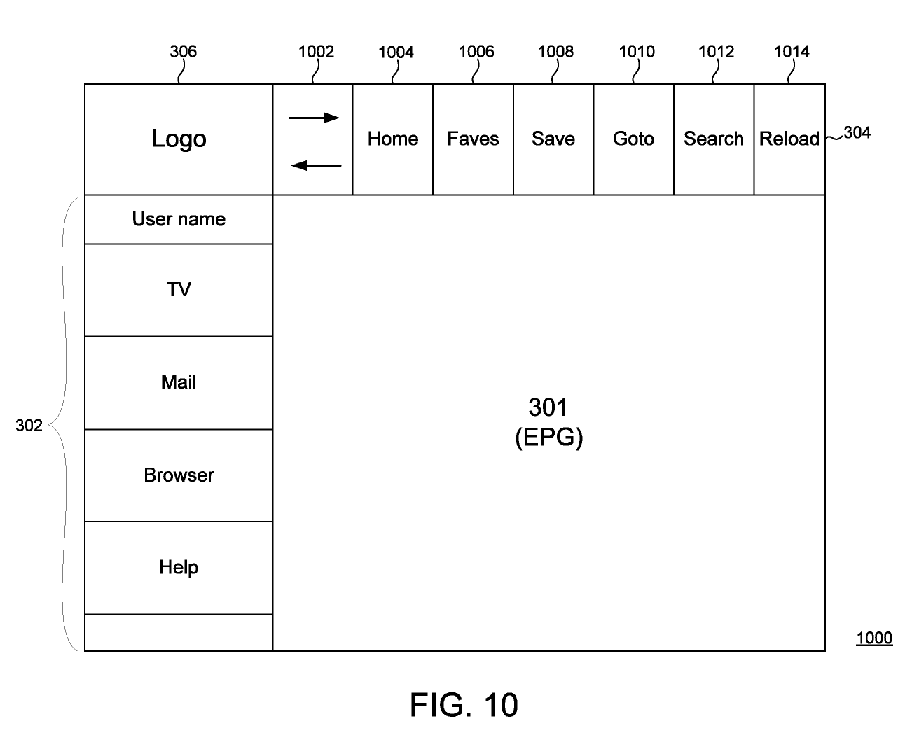

As the content in the display area 301 varies, so will the information and control icons in the context-sensitive area 304. For example, first, when display area 301 contains TV content, then context-sensitive area 304 may have the information shown in FIG. 3. Second, when the display area 301 contains electronic programming guide (EPG) content, then context-sensitive area 304 may have the controls described in relation to FIG. 7. Third, when display area 301 contains web content, then context-sensitive area 304 may have the controls described in relation to FIG. 10.

The logo area 306 may display, for example, a logo and name for a service provider. In this example, the service provider is named Charter Communications™.

While the particular layout of FIG. 3 shows a “L” configured UI along the top and left sides of the display, other “L” configurations are also contemplated and within the scope of the present invention. For example, the “L” configured UI may instead be along the bottom and left sides, or the bottom and right sides, or the top and right sides.

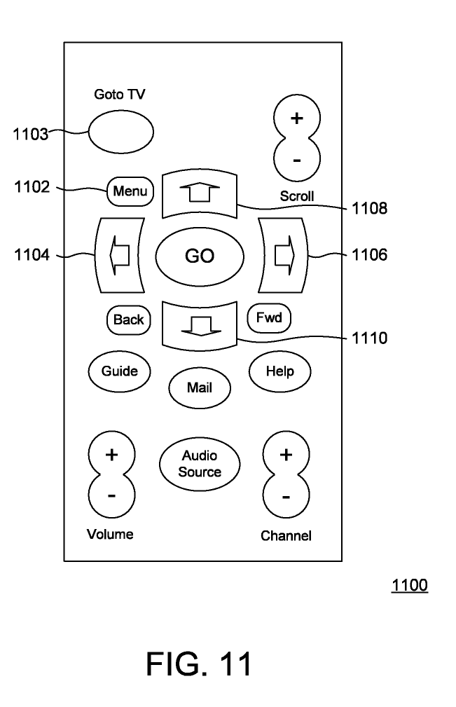

In accordance with an embodiment of the present invention, a first pair of arrows on a remote control navigates among the primary controls, and a second pair of arrows (perpendicular to the first pair) navigates among the context-sensitive controls. Switching between navigation among the primary controls and navigation among the context-sensitive controls occurs automatically upon switching between using the first pair of arrows and using the second pair of arrows. An example of a remote control with such arrows is shown in FIG. 11 which is described below.

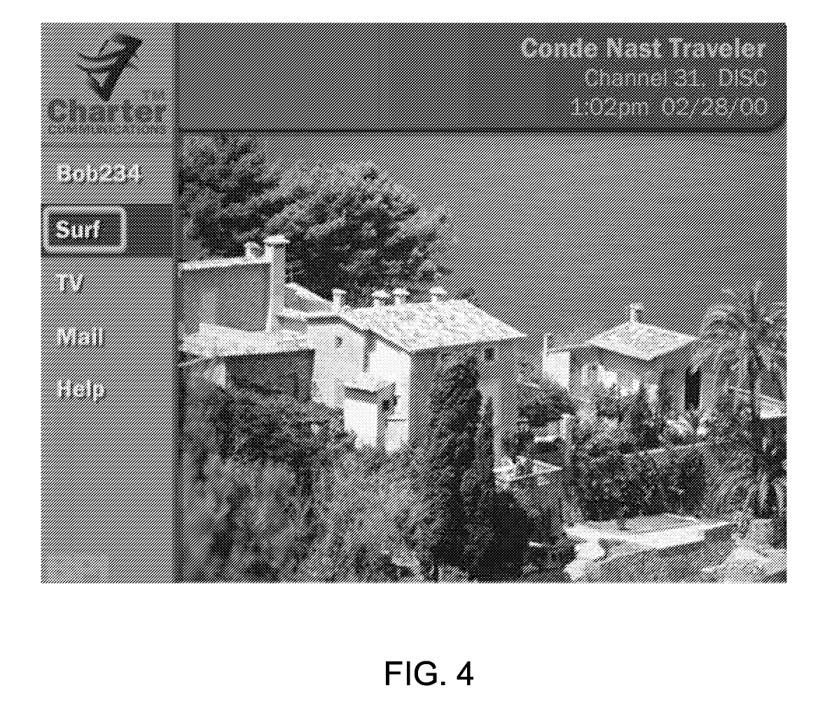

FIG. 4 is an illustrative screen frame of a UI which has been activated in accordance with an embodiment of the present invention. The frame shown in FIG. 4 is an implementation in close (but not exact) correspondence to the layout 300 of FIG. 3. Like the layout 300 in FIG. 3, the UI of FIG. 4 has primary controls on the left side, a context-sensitive area on the top, and a service provider's logo at the upper left corner.

Regarding the primary controls, “Bob234” is an example name of a currently active user. The “Surf” control corresponds to the browser control. Regarding the context-sensitive area, “Conde Nast Traveler” corresponds to the program title. “Channel 31, DSC” corresponds to the channel/network call letters. And, finally, “1:02 pm Feb. 28, 2000” corresponds to the current time (and date).

FIG. 5 depicts an example layout 500 of an UI with a user submenu 502 activated in accordance with an embodiment of the present invention. The user submenu 502 is activated by selecting the “user name” on-screen control from the group of primary controls 302. The user submenu 502 may include various selections.

The “family” user is the default selection when the UI is activated. In one embodiment, the family user will be able to access only content which is accessible to all other users. In other words, the family user will have a “permission space” which is the intersection of permission spaces of all other users. Advantageously, this feature does not require a password to be entered upon turning on the TV. Nevertheless, this feature may be used to prevent children from accessing excessively violent or adult-oriented content. Moreover, the protection provided may extend to both TV and Internet content.

User #2, user #3, . . . , user #N, may be individual user names, each of which may have a password to protect against entry by an unauthorized person. For example, the different users may correspond to members of a family. These user names may be sorted alphabetically in the user submenu 502. When an individual user name is selected and password, if any, entered correctly, then the user name becomes the active user.

The “manage users” and “settings” selections may be used to perform such function as: editing user name, password, and other user-related information for a specified user account; allowing users to block certain emails; allowing a user with administrative privileges to add or remove users and change user privileges; and so on.

FIG. 6 depicts an example layout 600 of a UI with a TV submenu 602 activated in accordance with an embodiment of the present invention. The TV submenu 602 is activated by selecting the “tv” on-screen control from the group of primary controls 302. The TV submenu 602 may include various selections.

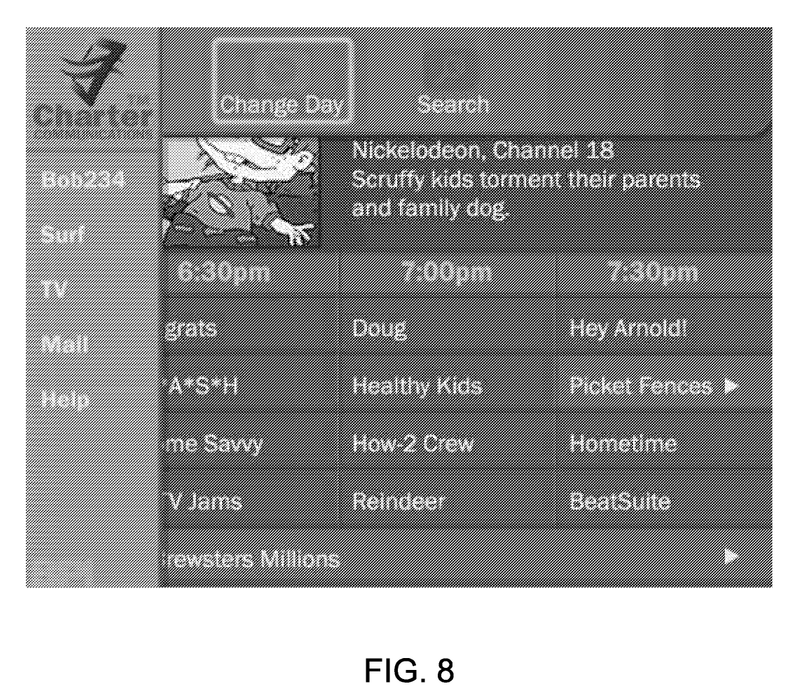

The “listing” selection provides an electronic programming guide (EPG) to broadcast TV content. When the EPG is provide, corresponding controls are provided in the context-sensitive area 304 as described below in relation to FIG. 7. An example of such an EPG within the UI is illustrated in FIG. 8 which is also described below.

The “info” selection provides information relating to the TV program currently being viewed in the display area 301. The information may include a brief description of the program, names of actors/actresses, copyright year, and so on.

The TV “favorites” selection provides a user with a list of his/her favorite TV channels. When a TV channel is selected from the favorite list, then the embedded TV display changes to that channel.

The TV “recents” selection provides small screen video images of the last N (where N is a positive integer) TV channels viewed. For example, if N=9, then video images of the 9 most recently viewed TV channels may be shown in a 3×3 matrix configuration in the embedded display 301. The number N may be fixed, or it may be user selectable.

The TV “search” selection provides a mechanism to search electronic program guide (EPG) listings for a particular program or programs. The search may be by program title, type of program (e.g., “basketball” may be searched to find basketball games being broadcast), by actor/actress, and so on.

These and other selections may be provided in the TV submenu 602. For example, “recent links” and “channel setup” selections are depicted in the TV submenu 602 of FIG. 6. The “recent links” selection provides access to hyperlinks recently received via a mechanism such as an ATVEF (Advanced TV Enhancement Forum) trigger. ATVEF is a cross-industry alliance of companies from broadcast and cable networks, television transport, consumer electronics, and personal computer industries. The “channel setup” selection allows a user to specify which TV channels are included as channels to tune to as part of the channel up/down tuning sequence.

FIG. 7 depicts an example layout 700 of a UI with television listing controls in the context-sensitive area 304 in accordance with an embodiment of the present invention. The television listing controls are provide when the display area 301 is used to provide an electronic programming guide (EPG).

The television listing controls shown in FIG. 7 include a “change day” control, an EPG “search” control, and a “stay on channel” control. The “change day” control allows the user to change the day of the program grid being shown by the EPG. The EPG “search” control provides access to a mechanism to search EPG listings for a particular program or programs. The “stay on channel” control comprises a toggle control to activate/deactivate this option. When the option is deactivated, then the TV tuner actively tunes to the selected channel in the program grid of the EPG. When the option is activated, then the TV tuner remains on the channel that was being displayed before entering the EPG.

FIG. 8 is an illustrative screen frame of a UI in a TV listing mode which provides an electronic programming guide (EPG) in accordance with an embodiment of the present invention. The frame shown in FIG. 8 is an implementation in close (but not exact) correspondence to the layout 700 of FIG. 7. (The frame of FIG. 8, for example, does not show a “stay on channel” toggle control.) The EPG shown provides a programming grid including rows representing different channels, and columns representing different timeslots. Other implementations of an EPG are also possible.

FIG. 9 depicts an example layout 900 of a UI with a browser submenu 902 activated in accordance with an embodiment of the present invention. The browser submenu 902 is activated by selecting the “browser” on-screen control from the group of primary controls 302. The browser submenu 902 may include various selections.

The “home” selection may provide access to a web page designated by a service provider (e.g., a MSO) as its “home” page. In one embodiment, when going to the home page, the L configured UI retracts, so that the home page is shown on a full-size screen.

The “user defined” selections provide access to specialized web pages which may be focused to various categories of content. For example, the specialized web pages may focus on categories such as news, money, sports, weather, entertainment, and others. Again, in one embodiment, when going to a specialized web page, the L configured UI retracts, so that the specialized page is shown on a full-size screen.

These and other selections may be provided in the browser submenu 902. For example, “more,” “go to,” browser “favorites,” and browser “search” selections are depicted in the browser submenu 902 shown in FIG. 9. The “more” button provides access to other categories of content in addition to those specified by the “user defined” selections described above. The “go to” button provides a query text box which allows a user to specify a URL to be displayed in the browser. The browser “favorites” button provides access to an organized data structure of favorite links. These browser favorites may be provided separately from the TV favorites, or they may be provided together in an integrated data structure. The browser “search” control provides access to a mechanism to search for particular Internet or Web content. The browser search may be provided separately from the EPG search, or they may be provided together in an integrated search feature.

FIG. 10 depicts an example layout 1000 of a UI with browser controls in the context-sensitive area 304 in accordance with an embodiment of the present invention. The browser controls are provided when the display area 301 is used to access World Wide Web content and other similar hyperlinked content.

In the embodiment shown in FIG. 10, the left and right arrows 1002 may be individually selected. The left arrow scrolls or shifts the browser controls one button to the left. For example, in FIG. 10, the left arrow would cause the “home” button 1004 to scroll “behind” the arrows 1002 and a control button (not shown) to the right of the “reload” button 1014 to become visible at the right side of the context-sensitive area 304. Similarly, the right arrow scrolls or shifts the browser controls one button to the right.

In the embodiment shown in FIG. 10, the “home” button 1004 may provide access to a web page designated by a service provider (e.g., a MSO) as its “home” page. The “faves” or favorites button 1006 provides access to a list of web pages or URLs that the user selects as his/her favorites. The “save” button 1008 enables a user to save a web page currently being displayed as a favorite page. The “go to” button 1010 provides a query text box which allows a user to specify a URL to be displayed in the browser. The “search” button 1012 provides access to a mechanism to search for particular Internet or Web content. The “reload” button 1014 causes the content currently in the display 301 to be refreshed.

Other buttons may be provided to the right of the “reload” button 1014. In one embodiment, the other buttons may include a “print” button, a “find” button, a “send” button, and an “info” button. The “print” button provides for printing, with various options, of the web page being displayed. The “find” button provides for finding a specified text string within the web page being displayed. The “send” button provides for sending an email with the web page being displayed or its URL attached thereto or contained therein. Finally, the “info” button provides additional information about the web page being displayed.

FIG. 11 is an illustrative design for a remote control 1100 in accordance with an embodiment of the present invention. Many other designs with similar functionality are, of course, possible and would be within the scope of the present invention.

The menu button 1102 may be used to activate and deactivate the UI as described above in relation to FIG. 3. The “Go To TV” button 1103 returns the display to a full-screen television display as illustrated by FIG. 2.

The up arrow 1108 and down arrow 1110 may be used to navigate among the primary controls 302. The left arrow 1104 and right arrow 1106 may be used to navigate among controls in the context-sensitive area 304. Switching between navigation among the primary controls and navigation among the context-sensitive controls occurs automatically upon switching between using the up/down arrows 1108/1110 and using the left/right arrows 1104/1106. The “Go” button (which may also be designated the “OK” button) selects the screen object currently pointed to and triggers whatever event is associated with the object.

In accordance with an embodiment of the present invention, the user interface may advantageously be user customizable to speed-up and facilitate access to content desired by the user. For example, options or selections may be customizable by the user to be integrated with the user interface. In one particular instance, selections of synthetic channels focusing on specialized content categories may be chosen by a user to be integrated with the user interface.

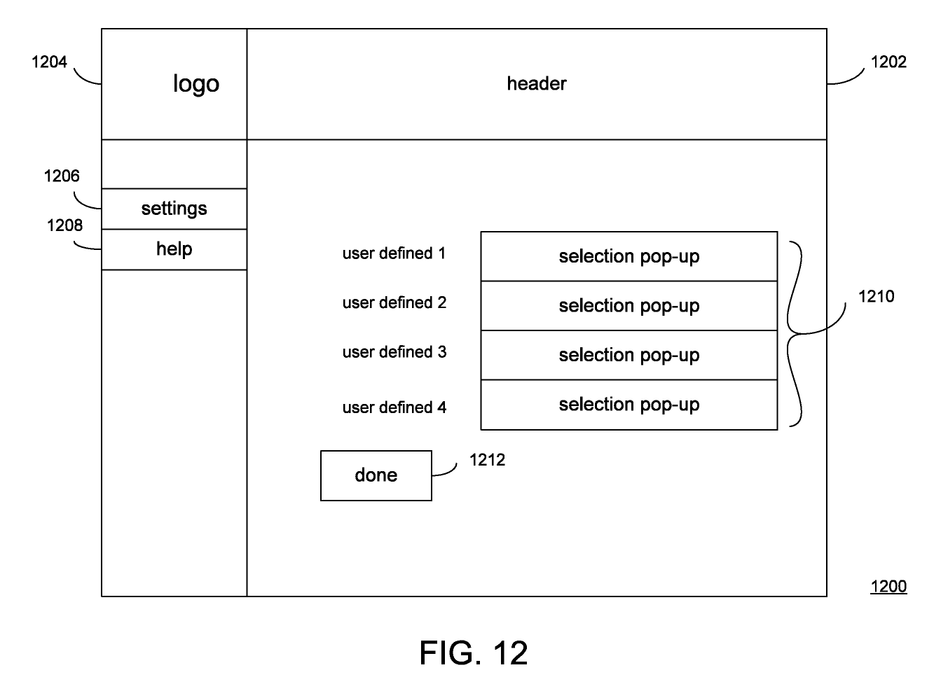

FIG. 12 depicts a synthetic channel settings page 1200 for user customization of selections of synthetic channels focusing on specialized content categories in accordance with an embodiment of the present invention. This page 1200 may be reached, for example, by way of the settings selection from the user submenu 502 depicted in FIG. 5 and described above in relation thereto. In particular, the settings selection may lead to a more general user settings page which may in turn lead to the synthetic channel settings page 1200.

The synthetic channel settings page 1200 depicted in FIG. 12 includes a header 1202, a logo 1204, a settings control 1206, a help control 1208, a plurality of user customizable selections of synthetic channels 1210, and a “done” button 1212. The header 1202 may or may not include selectable elements. The logo 1204 may be the same as the logo area 306 in FIG. 3. The settings control 1206 may be a control which leads to a submenu of various settings pages, one of which would be the synthetic channel settings page 1200. The plurality of user customizable selections of synthetic channels 1210 may allow the user to select several (for example, four) synthetic channels for integration, for example, into the browser submenu 902 depicted in FIG. 9. As depicted in FIG. 12, the selections may be made by pop-up menus, but other mechanisms for making the selections may also be utilized. The done button 1212 would be pressed when a user is finished selecting the synthetic channels.

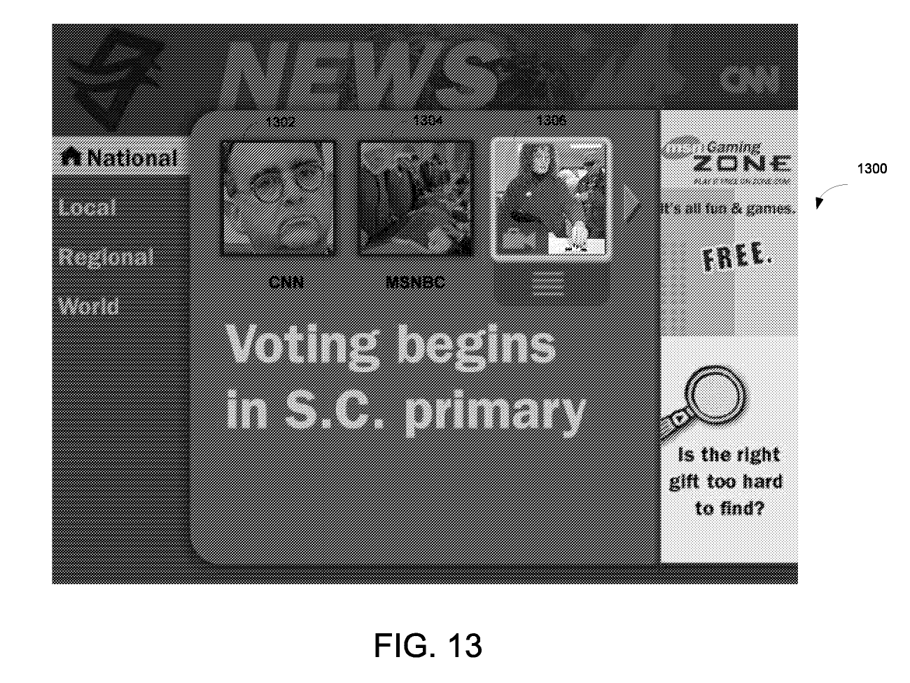

FIGS. 13-16 depict exemplary pages of synthetic channels focusing on news categories for purposes of illustration. FIG. 13 depicts an exemplary synthetic channel page 1300 on general news. The page includes a plurality of channel icons such as a first news channel icon 1302 and a second news channel icon 1302 (other icons are not shown). The channel icons can be displaying still images or broadcasting in reduced size the contents being transmitted by the corresponding TV stations. The synthetic channel page enable a user to view at once multiple broadcasts and quickly select a desired channel to view by selecting one of the channel icons. For example, upon accessing the synthetic news channel page 1300, the user may decide to watch CNN over other channels by selecting the first channel icon.

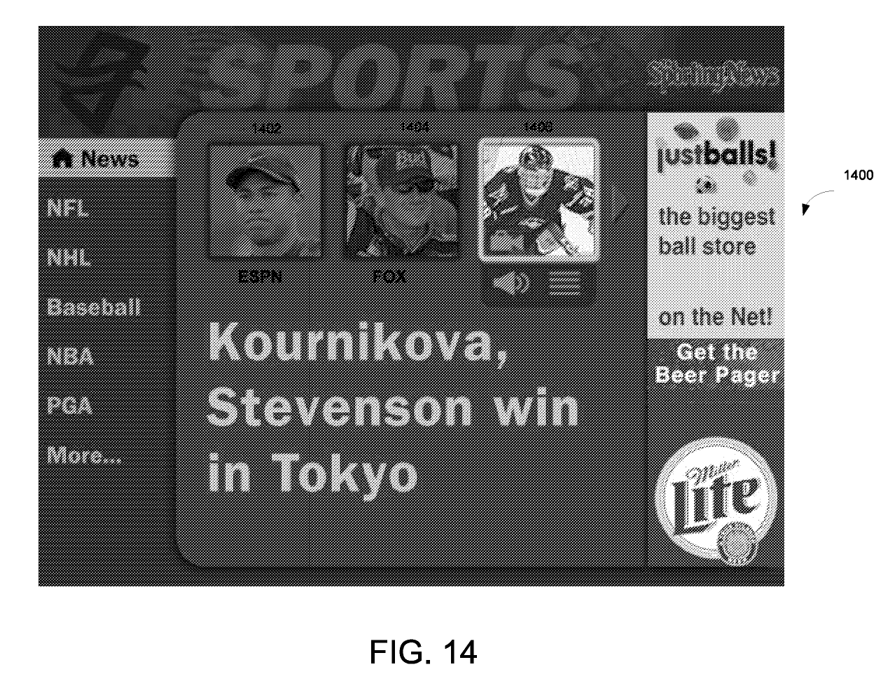

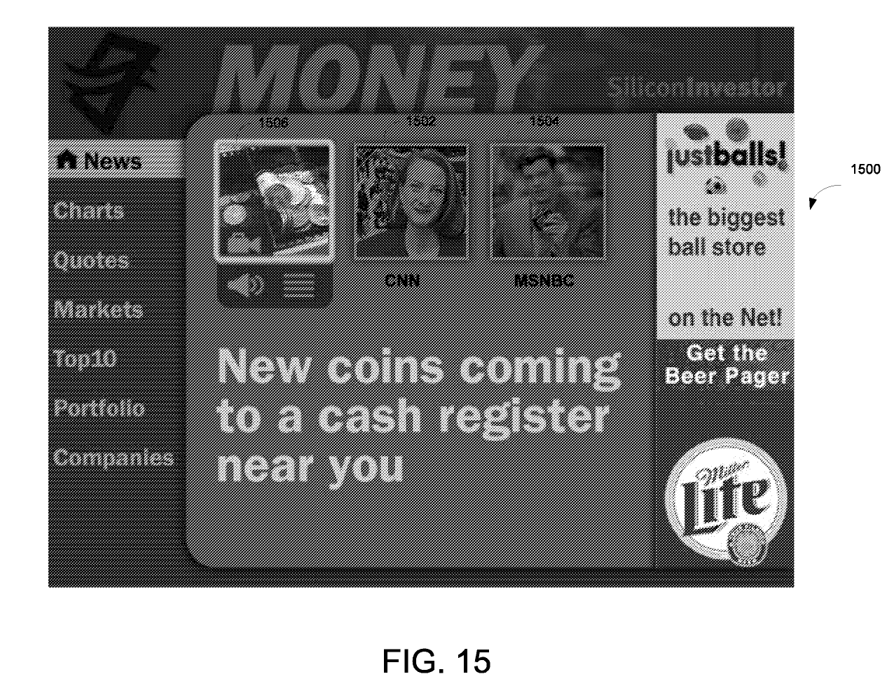

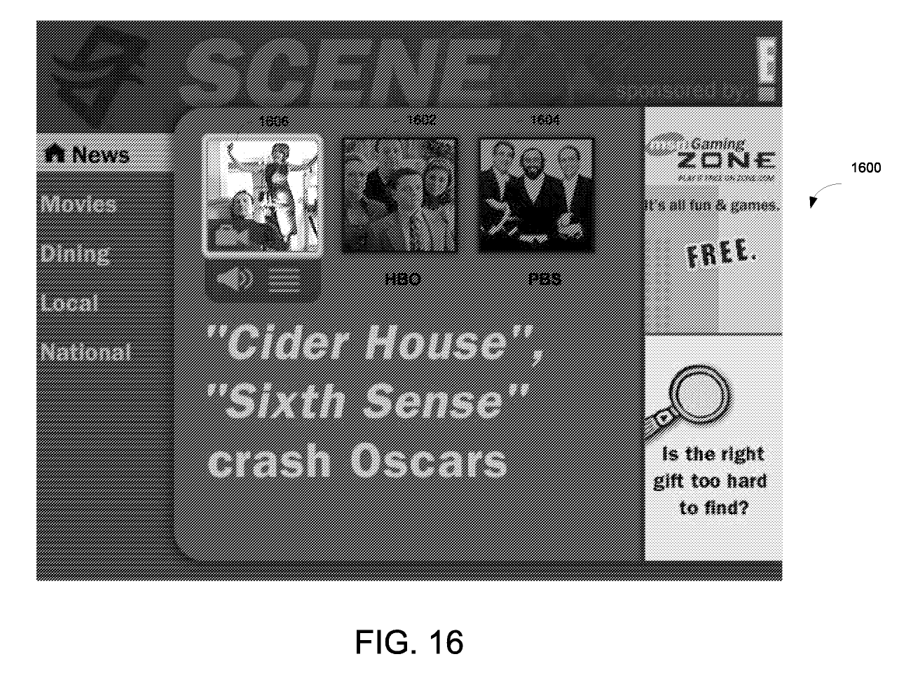

FIG. 14 depicts an exemplary synthetic channel page 1400 on sports news. The page 1400 includes a first sports news channel icon 1402 and a second sports news channel icon 1404. FIG. 15 depicts an exemplary synthetic channel page 1500 on financial news, including a first financial news channel icon 1502 and a second financial news channel icon 1504. Finally, FIG. 16 depicts an exemplary synthetic channel page 1602 on entertainment news, including a first entertainment news channel icon 1602 and a second entertainment new channel icon 1604.

Generally, the channel icons displayed on the synthetic channel pages are dynamically selected each time a user accesses one of the synthetic channel pages. For example, when a user selects to view the synthetic channel page 1300 on news, the set top box 108 searches for those channels that are currently broadcasting news contents and displays selected channels meeting this requirement, such as the channel icons 1302 and 1304 for CNN and MSNBC, on the screen. In one implementation, the user may select to have some channel icons appear always with a particular synthetic channel page. For example, a user may select to have an HBO channel icon appear whenever the user accesses a synthetic channel page on movies or entertainment, regardless of whether HBO is broadcasting a movie at that particular time.

In one implementation, the synthetic pages may include one or more channel icons that display the names or logos of the channels and do not display either still video images or streaming video contents. The synthetic pages may also include one or more relevant segments of previously broadcast TV contents. Such pre-recorded television broadcast contents may be stored locally at a set top unit or remotely at a server unit.

The synthetic channels may be more specific and more specialized than the pages in FIGS. 13-16. For example, instead of focusing on sports news in general, synthetic channels may focus more specifically on news relating to particular favorite sports of a user, such as basketball, baseball, football, soccer, and so on. A synthetic channel may also focus on one or more specific favorite sports team of a user, such as the Portland Trailblazers basketball team, and/or the Seattle Mariners baseball team, and/or the Seattle Seahawks football team. As another example, a synthetic channel may focus on news relating to one or more region of the world or one or more country. As yet another example, a synthetic channel may focus on one or more particular area of finance, such as technology stocks, or on particular companies or stocks. As a final example, a synthetic channel may focus on one or more particular type or genre of entertainment, or on particular entertainers or celebrities or shows.

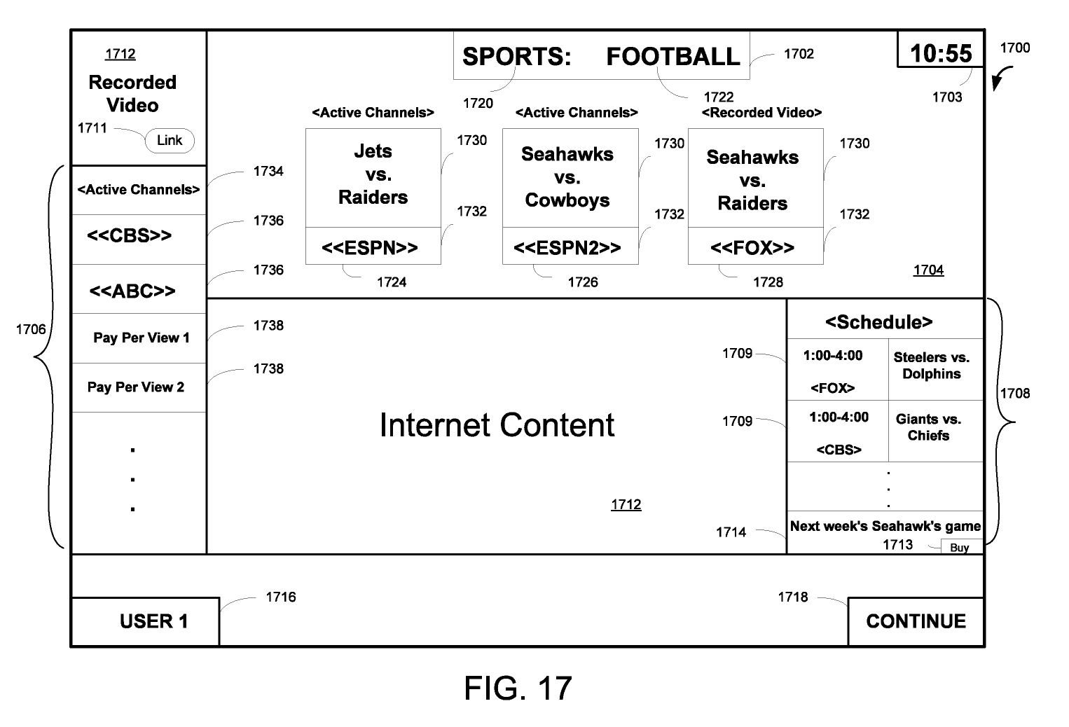

FIG. 17 depicts an exemplary synthetic page 1700 on a subject matter other than news, on sports, more particularly on football, according to one embodiment of the present invention. The page 1700 includes a title section 1702, a time display section 1703, a television content section 1704, an active channel section 1706, a schedule section 1708, a recorded video section 1710, an Internet content section 1712, a user identification section 1716, and a continue icon 1718.

The title section 1702 identifies the synthetic channel page being displayed and may include a generic section 1720 and a specific section 1722. The generic section describes the general category of the synthetic channel page, such as sports, news, weather, and the like. The specific section describes a specific category within the general category that the user had selected, in this case: football. The time display section 1703 displays the current time.

The television content section 1704 generally includes a plurality of active channel icons 1724 and 1726 that provide links to the channels that display the contents of interest to the user (in this case, football games) and a recorded video icon 1728 that provides a link to pre-recorded video content of interest to the user. For example, the recorded video icon 1728 provides a link to previously televised football game of the user's favorite team: Seahawks. The icons may be represented by streaming video, still video images, or explanatory words or logos. Generally, the active channel icon includes a display area 1730 to display the video contents being broadcast by the corresponding TV station and a channel identification section 1732 to identify the TV station that is broadcasting the video contents. The user may view the desired video contents in full-sized images by selecting one of the icons 1724, 1726, or 1728. As used herein, the term “TV station” and “TV channel” are used interchangeably.

The active channel section 1706 includes a title 1734, one or more TV station links providing links to the TV stations that are currently broadcasting football games, and one or more pay-per-view links 1738 providing links to pay-per-view broadcast contents on football games. The links 1736 and 1738 may include information on the teams playing, the scheduled broadcast time, and the like, to assist the user in quickly selecting which game to watch. As with the television content section, the active channel section 1706 only lists the TV channel and pay-per-view links that are currently broadcasting the contents of interest to the user (i.e., football games), as identified by the title section 1702.

In one implementation, some TV stations may be given preference over others in providing the former with active channel icons on the television content section 1704. For example, FOX, CBS, and ESPN may pay to have their respective channel icons appear on the television content section 1704 over other channels. Those channels that are not provided with the channel icons would be displayed in the active channel section 1706. Alternatively, a user may specify which TV stations or channels are to be represented with the active channel icons on his or her synthetic channel page. In another implementation, the user may provide the UI with the names of football team of interest to him or her. The set top unit 108 then provides the TV stations that broadcast the games of those teams with the active channel icons 1724 and 1726. Yet in another implementation, a combination of the above implementations may be used.

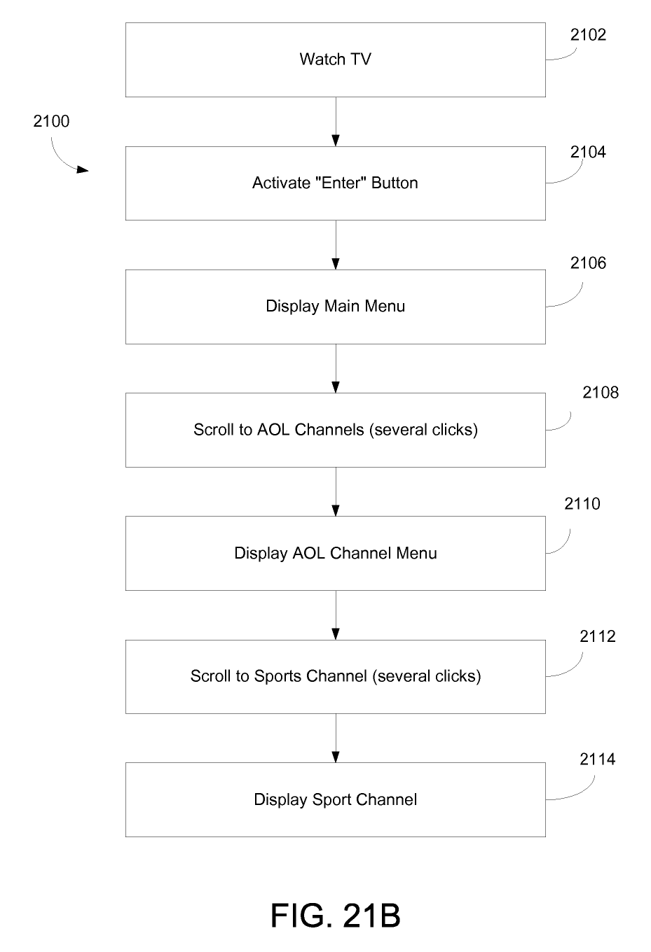

The schedule section 1708 includes a plurality of first slots displaying a list of upcoming football games to be broadcast and one or more of second slots 1714 displaying a list of football games to which the user is likely to purchase tickets to see the games in person. If the user is interested purchasing the ticket, he or she may select the appropriate second slot and press a buy button 2222 on a remote control 2200 (FIG. 22) or simply select a buy icon 1713.

The recorded video section 1710 displays video contents previously broadcast by the TV stations and may include a plurality of icons (not shown) from which the user can select a desired pre-recorded game to view. The icons may be for previously televised football games by TV stations or previously broadcast pay-per-view football games which may be viewed for some amount of money. In one implementation, the recorded video section may provide a link 1711 to another page that is dedicated to the pre-recorded football games.

The Internet content section 1712 includes one or more of the following: a link to Web site relating to football, e.g., www.NFL.com, an article relating to football in general, an article relating to particular team or athlete as specified by the user, a streaming video clip relating to football, and the like. The user identification section 1716 identifies the user for whom the synthetic page 1700 has been customized. The continue section 1718 may be selected to display another synthetic page directed to sports, which may be dedicated to another sports, e.g., basketball, or to a particular football team, e.g., Seattle Seahawks, or to a particular person, e.g., Jerry Rice, or the like.

As illustrated in FIGS. 13-17, according to embodiments of the present invention, the synthetic channel page provides a user with a convenient “one-stop” location to view an aggregation of multiple television broadcast channels and web contents on a unified subject. For example, a synthetic sports channel page may include reduced-sized displays of ESPN, ESPN2, Fox Sports, and perhaps network channels currently broadcasting sports events. By such an aggregation, a user may advantageously view at once the multiple broadcasts and make a rapid and more informed decision as to which sports event he or she wants to view. A full-sized display of a particular broadcast would be conveniently accessible from the synthetic sports channel (e.g., by selection of the particular reduced-size display). One may think of this aspect of the invention as a one-button to many channel mapping.

In addition, the synthetic channel page may include web content in combination with the TV content, both relating to a unified subject. Continuing with the above example on the synthetic sports channel page, the web content may include the latest sports news stories accompanied by broadband streaming video clips with highlights relating to those stories. The web content may also include access to web sites such as NBA.com. Such integration of web and TV content advantageously provides a user with one-click, single device access to the specialized content in which he or she is interested.

Moreover, the synthetic channel page may be customizable or semi-customizable by a user, as explained previously in connection with FIGS. 13-17. For example, a user interested primarily in basketball and golf may choose to have the synthetic channel focus on web and TV contents related to those sports. As another example, a user may have the synthetic channel focus on web and TV contents related to his favorite sports teams (or even favorite sports personalities such as Tiger Woods). Such customization advantageously saves a sports fan time by focusing on his favorite sports or teams.

In one implementation, the synthetic channel page provides a plurality of sections or mini-synthetic channel pages, e.g., two sections, dedicated to a plurality of subjects. That is, a plurality of synthetic channel pages may be displayed together on the display area simultaneously, e.g., the left half dedicated to a synthetic weather channel page and the right half dedicated to a synthetic shopping channel page. Alternatively, the display system may display a combination of regular synthetic channel pages for popular subject, e.g., sports, and mini-synthetic channel pages for less popular subject, e.g., weather. A user may customize the display system to determine which subjects are to be displayed as regular pages and which are to be displayed as “mini” pages, according to his or her interest.

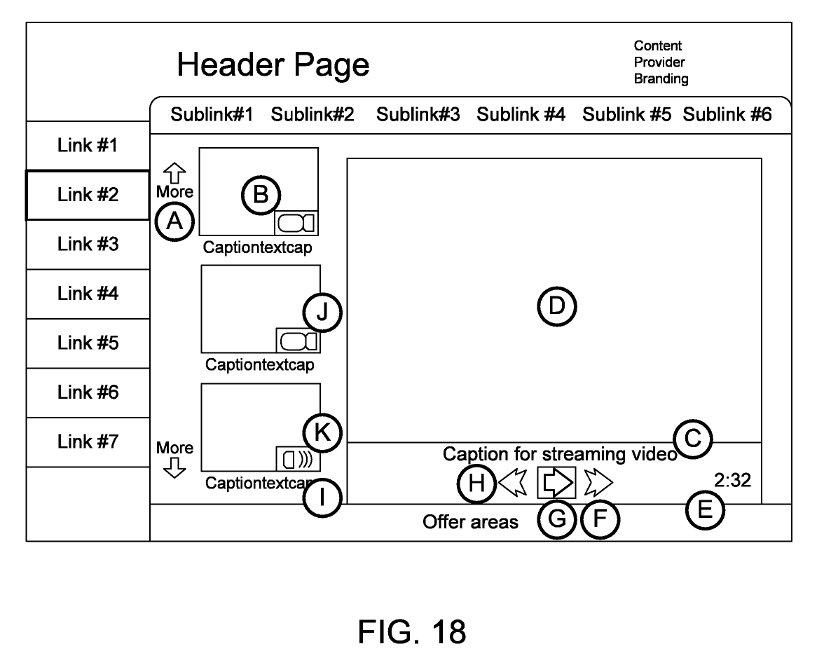

Referring to FIGS. 13-16, the synthetic pages includes multimedia bars 1306, 1406, 1506, and 1606 as part of the user interface to provide a unified mechanism for user-friendly integrated access to various types (video, audio, and text) of digital multimedia content. Each synthetic page may include a plurality of such multimedia bars. Such multimedia bars are described in further detail below in relation to FIGS. 18-21.

FIG. 18 depicts a user interface which includes a multimedia bar and an embedded media viewer in accordance with an embodiment of the present invention. The depiction in FIG. 17 includes eleven features labeled using the letters A, B, C, D, E, F, G, H, I, J, and K. As used herein, the term “multimedia bar” includes the channel icons.

As described below, the features may (or may not) be selectable. Preferably, selection is accomplished using arrow or other buttons on a remote control device. Selection may also be accomplished by other means (mouse pointing devices, trackballs, joysticks, touch screens, voice recognition, and so on). When a feature or object is selected, it may be highlighted or marked in some manner to so indicate its selection. For example, feature labeled G in FIG. 18 is depicted as being highlighted by a “selection rectangle” outlining the feature.

Once a feature is selected, it may be activated. Such activation may be accomplished by pressing an “OK” or similar button on the remote control device. Activation may also be accomplished by other means (clicking a mouse button, etc.).

The feature labeled A in FIG. 18 comprises one of two selectable “more” buttons. The two more buttons point in opposing directions. In this embodiments, the opposing directions are up and down, but in other embodiments the opposing directions may be left and right. When a more button is activated, the current set of reduced-size images will be scrolled to the next set of reduced-size images which are not currently visible in the direction selected. If there are no more reduced-size images in the direction indicated by the more button, then that more button will be hidden (neither visible nor available) in the multimedia bar.

The feature labeled B in FIG. 18 comprises one of a set of selectable reduced-size images. Preferably, these reduced-size images should be of sufficient quality and layout so that they can be recognized by a person with normal vision on an ordinary sized television from about 10 feet away. Preferably, the reduced-size image will provide a good visual indicator about the content of the associated digital content. When the digital content comprises a streaming video clip, then the reduced-size image may frequently (but not necessarily) be a first frame of the streaming video clip.

Each reduced-size image relating to a subject matter may operate as a hyperlink to associated digital content. A reduced-size image may be selected using means as described above. If the reduced-size image is located at an edge (either first or last position of) the multimedia bar, and there is a next image “hidden” beyond the edge, then a logical scroll of the reduced-size images occur so as to reveal that next image.

Once the reduced-size image has been selected, then it may be activated using means as described above. Once activated, the associated digital content will be presented. For example, if the associated digital content comprises a streaming video clip, then the video clip will be loaded into the viewing window for playback. In a preferred embodiment, such playback may be initiated automatically if there is sufficient throughput to maintain the clips required bit rate. If not, the viewer may buffer the video stream automatically.

Possibly in some embodiments, the associated digital content may comprise a still image. In that case, when the reduced-size image is activated, then the image will be loaded into an image viewer for display (typically at full-size or at least a size greater than the reduced-size image).

The feature labeled C in FIG. 18 comprises an area to display a caption for content being displayed by the embedded media viewer. In a preferred embodiment, the caption comprises non-selectable text.

The feature labeled D in FIG. 18 comprises a viewing window for displaying content by the embedded media viewer. In a preferred embodiment, the viewing window may display streaming video clips. Preferably, the streaming video clips will be created such that a first frame of the clip provides a good visual indicator about the clip's contents.

The feature labeled E in FIG. 18 comprises an elapsed time indicator for the content being displayed by the embedded media viewer. Such an elapsed time indicator would be used to display the amount of elapsed time during play of streaming video by the embedded media viewer.

The feature labeled F in FIG. 18 comprises a selectable fast forward button for the content being displayed by the embedded media viewer. In a preferred embodiment, activating the fast forward button causes the streaming media clip to be fast forwarded until it either reaches the end of the streaming media clip or until the play button is selected.

The feature labeled G in FIG. 18 comprises a selectable play/pause button. In a preferred embodiment, such a play/pause button may comprise a two-state button. When the streaming media clip is playing in the embedded media viewer, the play/pause button is in a “pause” state where it resembles and represents a pause button (not illustrated in FIG. 17). Activating the play/pause button from pause state causes pausing of the streaming media clip and further causes the play/pause button to change to a “play” state where it resembles and represents a play button (as illustrated in FIG. 17). Activating the play/pause button from play state causes playing of the streaming media clip and further causes the play/pause button to change to the “pause” state

The feature labeled H in FIG. 18 comprises a selectable rewind button. In a preferred embodiment, activating the rewind button causes the streaming media clip to rewind until either the beginning of the clip is reached or until the play button is activated.

The feature labeled I in FIG. 18 comprises an area to display a caption for subject matter depicted in a corresponding reduced-size image. In a preferred embodiment, the caption comprises non-selectable text.

The feature labeled J in FIG. 18 comprises a video icon corresponding to a subject matter. In a preferred embodiment, the video icon is non-selectable and indicates the presence of a streaming video clip associated with the subject matter. Such a streaming video clip may be viewable by way of the viewing window (D) described above.

The feature labeled K in FIG. 18 comprises an audio icon corresponding to a subject matter. In a preferred embodiment, the audio icon is non-selectable and indicates the presence of a streaming audio clip associated with the subject matter. Such audio content may be played on an audio system either integrated with the video system or external to the video system.

If both video and audio icon are present in correspondence to a subject matter, then both a streaming video clip and a streaming audio clip are associated with the subject matter. Such streaming video and audio are preferably in synchronization with each other and played together synchronously.

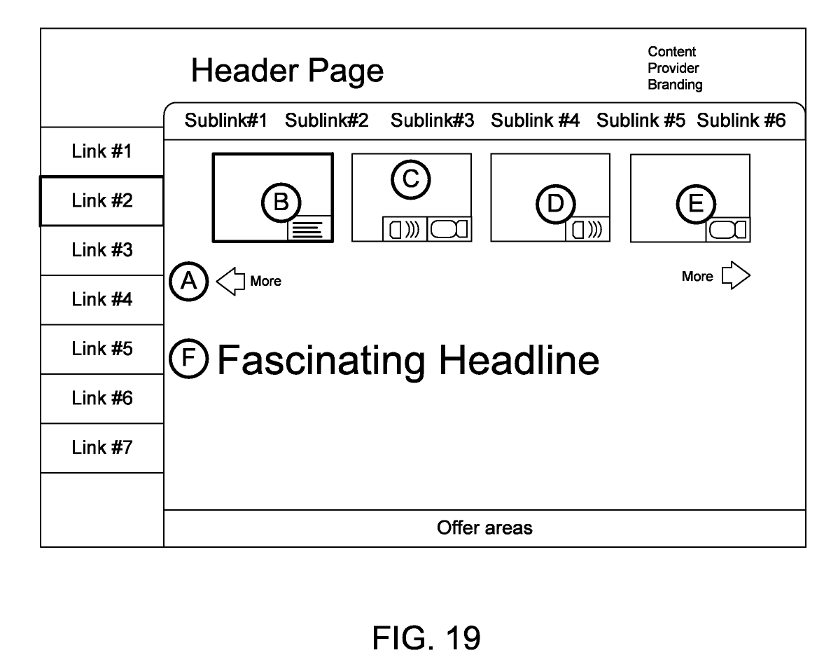

FIG. 19 depicts a user interface which includes a multimedia bar for use with pop-up media viewers in accordance with an embodiment of the present invention. Such an embodiment may be preferable for use on a user interface page where multimedia presentation functionality is desired, but where there is insufficient space available on the page for an embedded viewer. The depiction in FIG. 18 includes six features labeled using the letters A, B, C, D, E, and F.

The feature labeled A in FIG. 19 (like feature A in FIG. 18) comprises one of two selectable “more” buttons. The two more buttons point in opposing directions. In this embodiments, the opposing directions are left and right, but in other embodiments the opposing directions may be up and down. When a more button is activated, the current set of reduced-size images will be scrolled to the next set of reduced-size images which are not currently visible in the direction selected. If there are no more reduced-size images in the direction indicated by the more button, then that more button will be hidden (neither visible nor available) in the multimedia bar.

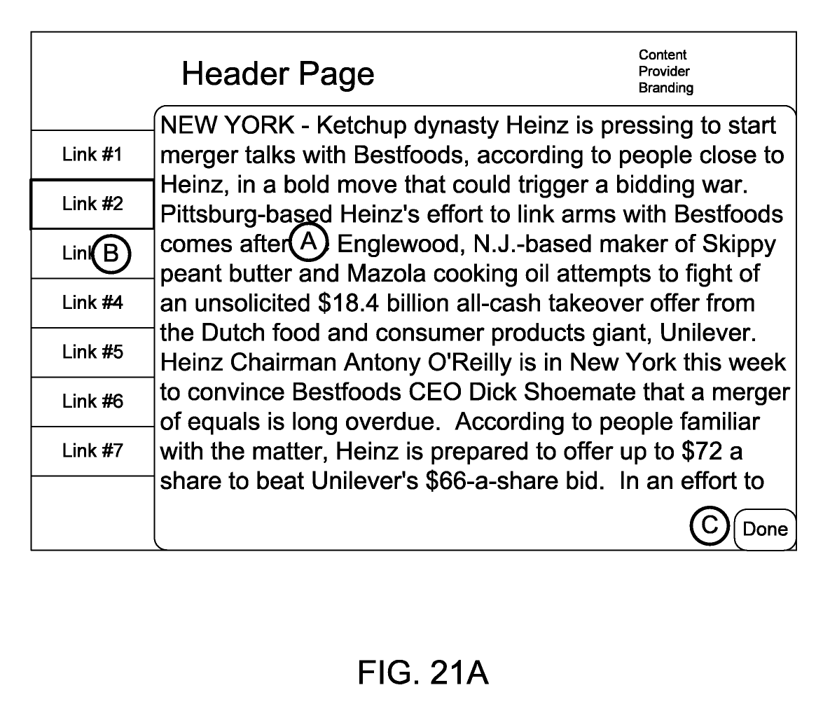

The feature labeled B in FIG. 19 comprises a selectable text icon corresponding to a subject matter. Each text icon may operate as a hyperlink to associated text content. If there is only text content corresponding to a subject matter (i.e. no video, no audio, and no reduced-size image), then the text icon may be larger such that it overlays the space where the reduced-size image would otherwise be. The text icon may be selected using means as described above. Once the text icon has been selected, then it may be activated using means as described above. Once activated, the text content may be viewable by way of a pop-up text viewer as described below in relation to FIG. 21.

The feature labeled C in FIG. 19 (like feature B in FIG. 18) comprises one of a set of selectable reduced-size images. Preferably, these reduced-size images should be of sufficient quality and layout so that they can be recognized by a person with normal vision on an ordinary sized television from about 10 feet away. Preferably, the reduced-size image will provide a good visual indicator about the content of the associated digital content. When the digital content comprises a streaming video clip, then the reduced-size image may frequently (but not necessarily) be a first frame of the streaming video clip.

Each reduced-size image may operate as a hyperlink to associated digital content relating to a subject matter. A reduced-size image may be selected using means as described above. For purposes of illustration, the reduced-size image to the left of the one labeled C in FIG. 19 is shown to be currently selected by the selection rectangle outlining it. If the reduced-size image is located at an edge (either first or last position of) the multimedia bar, and there is a next image “hidden” beyond the edge, then a logical scroll of the reduced-size images occur so as to reveal that next image.

Once the reduced-size image has been selected, then it may be activated using means as described above. Once activated, the associated digital content will be presented. For example, if the associated digital content comprises a streaming video clip, then the video clip will be loaded into the viewing window for playback. In a preferred embodiment, such playback may be initiated automatically if there is sufficient throughput to maintain the clips required bit rate. If not, the viewer may buffer the video stream automatically.

Possibly in some embodiments, the associated digital content may comprise a still image. In that case, when the reduced-size image is activated, then the image will be loaded into an image viewer for display (typically at full-size or at least a size greater than the reduced-size image).

The feature labeled D in FIG. 19 comprises an audio icon corresponding to a subject matter. In a preferred embodiment, the audio icon is non-selectable and indicates the presence of a streaming audio clip associated with the subject matter. Such audio content may be played on an audio system either integrated with the video system or external to the video system.

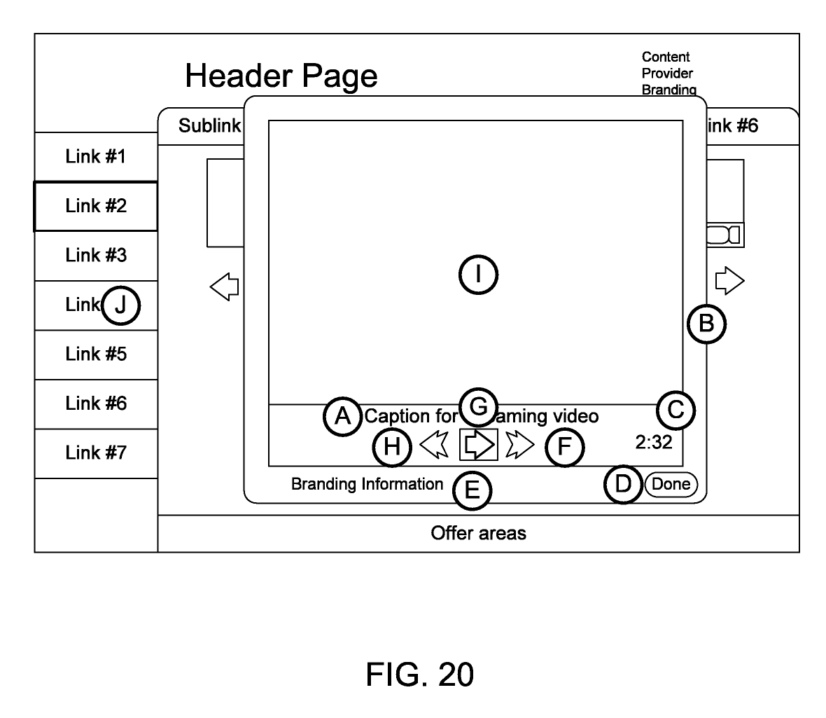

The feature labeled E in FIG. 19 comprises a video icon corresponding to a subject matter. In a preferred embodiment, the video icon is non-selectable and indicates the presence of a streaming video clip associated with the subject matter. Such a streaming video clip may be viewable by way of a pop-up media viewer as described below in relation to FIG. 20.

Again, if both video and audio icon are present in correspondence to a subject matter, then both a streaming video clip and a streaming audio clip are associated with the subject matter. Such streaming video and audio are preferably in synchronization with each other and played together synchronously.

The feature labeled F in FIG. 19 comprises a caption (or headline) relating to the subject matter of a selected reduced-size image or a selected text icon. The caption is displayed upon selection (not activation) of the reduced-size image or text icon, and the caption changes as the selected image or icon changes.

FIG. 20 depicts a pop-up media viewer overlaid over a screen in accordance with an embodiment of the present invention. The depiction in FIG. 20 includes ten features labeled using the letters A, B, C, D, E, F, G, H, I, and J.

The feature labeled A in FIG. 20 comprises an area to display a caption for content being displayed by the pop-up media viewer. In a preferred embodiment, the caption comprises non-selectable text.

The feature labeled B in FIG. 20 comprises a pop-up frame. The pop-up frame delimits the window for the pop-up media viewer.

The feature labeled C in FIG. 20 comprises an elapsed time indicator for the content being displayed by the pop-up media viewer. Such an elapsed time indicator would be used to display the amount of elapsed time during play of streaming video by the pop-up media viewer.

The feature labeled D in FIG. 20 comprises a selectable “done” button. Activating the done button causes the pop-up media viewer to be dismissed (go away), returning to the screen or page from which the pop-up media viewer was spawned.

The feature labeled E in FIG. 20 comprises an area to display a text or an image. In a preferred embodiment, the text or image is non-selectable and is used for purposes of brand marketing of the content provider or other business entity.

The feature labeled F in FIG. 20 comprises a selectable fast forward button for the content being displayed by the pop-up media viewer. In a preferred embodiment, activating the fast forward button causes the streaming media clip to be fast forwarded until it either reaches the end of the streaming media clip or until the play button is selected.

The feature labeled G in FIG. 20 comprises a selectable play/pause button. In a preferred embodiment, such a play/pause button may comprise a two-state button. When the streaming media clip is playing in the pop-up media viewer, the play/pause button is in a “pause” state where it resembles and represents a pause button (not illustrated in FIG. 19). Activating the play/pause button from pause state causes pausing of the streaming media clip and further causes the play/pause button to change to a “play” state where it resembles and represents a play button (as illustrated in FIG. 19). Activating the play/pause button from play state causes playing of the streaming media clip and further causes the play/pause button to change to the “pause” state

The feature labeled H in FIG. 20 comprises a selectable rewind button. In a preferred embodiment, activating the rewind button causes the streaming media clip to rewind until either the beginning of the clip is reached or until the play button is activated.

The feature labeled I in FIG. 20 comprises a viewing window for displaying content by the pop-up media viewer. In a preferred embodiment, the viewing window may display streaming video clips. Preferably, the streaming video clips will be created such that a first frame of the clip provides a good visual indicator about the clip's contents.

The feature labeled J in FIG. 20 comprises a translucent background overlay which is laid over the screen or page from which the pop-up media viewer was spawned. The translucent background overlay serves to de-emphasize the screen or page from which the pop-up media viewer was spawned and to emphasize the pop-up media viewer. In a preferred embodiment, the transparency attribute of the translucent background overlay may be set at 65% or thereabout (say from 50% to 80%).

FIG. 21A depicts a pop-up text viewer overlaid over a screen in accordance with an embodiment of the present invention. The depiction in FIG. 21A includes three features labeled using the letters A, B, and C.

The feature labeled A in FIG. 21A comprises a text viewing window for displaying text content. When there is more than one page of text content to be displayed, a scrolling capability is used to move between pages. Preferably, a scrolling capability of a browser portion of the user interface may be used to provide the scrolling capability of the text viewing window.

The feature labeled B in FIG. 21A comprises a translucent background overlay which is laid over the screen or page from which the pop-up text viewer was spawned. The translucent background overlay serves to de-emphasize the screen or page from which the pop-up text viewer was spawned and to emphasize the pop-up text viewer. In a preferred embodiment, the transparency attribute of the translucent background overlay may be set at 65% or thereabout (say from 50% to 80%).

The feature labeled C in FIG. 21A comprises a selectable “done” button. Activating the done button causes the pop-up text viewer to be dismissed (go away), returning to the screen or page from which the pop-up text viewer was spawned.

FIG. 21B depicts a method 2100, as disclosed in “www.aoltv.com/anywhere/aoltv/whatis.html,” used by AOLTV to access AOLTV Channels relating to Networks/Local, News, Sports, Kids & Family, and so on. Each AOLTV channel provides a specialized online content, e.g., Sports, in a single channel. The AOL Channel is similar to the synthetic channel pages described above, in that both provide television and web contents on a single channel or page. However, the AOLTV channel does not appear to provide in a single channel or page, among other features, a feature, such as television content section 1704 having a plurality of active channel icons 1724 and 1726, to allow a user to view multiple television broadcast channels simultaneously. Nor does it appear to provide a feature, such as recorded video icon 1728, to allow a user to view pre-recorded video contents. In addition, the AOLTV channels does not appear to provide a schedule-section-like feature that display upcoming events or television broadcast time or a recorded-video-section-like feature that is dedicated to provided pre-recorded video contents. Therefore, the synthetic channel pages provide significant better user experience than the AOLTV Channels. Moreover, the present inventor believes he has conceived the synthetic channel page concept prior to the AOL TV Channels inventor's conception of his or her invention.

As shown in FIG. 21B, AOLTV requires a user to perform numerous steps to navigate from viewing television (“TV mode”) to viewing an AOL channel, e.g., a sports channel (“Sports Channel mode”). Under the method 2100, a user initially views a television content (step 2102). The user activates an “enter” button on a keyboard to display a main menu (step 2104). As a result, the main menu is displayed on the display area (step 2106). The main menu is a vertical menu with a plurality of tabs vertically aligned. The user scrolls to “AOL Channels” tab and selects the tab (step 2108). This step requires several clicks to perform since the tab to be selected is placed within the inner portion of the vertical menu. An “AOL Channel” menu is displayed in response to the selection (step 2110). Like the main menu, the “AOL Channel” menu is a vertical menu with a plurality of channels vertically aligned. The user scrolls to “Sports” channel and selects the channel (step 2112). The step also requires several clicks to perform since the channel to be selected is provided within the inner portion of the vertical menu. A “Sports” channel is displayed in response to the selection made at step 2112 (step 2114). As illustrated, the method 2100 requires the user to make about ten clicks to navigate from the TV mode to the “Sports Channel” mode. Obviously, an improved method of navigating from a TV mode to a specialized mode, such as the “Sports Channel” mode, is desirable.

FIG. 22 shows an illustrative design for a remote control 2200 that a user can used to navigate from a TV mode to a synthetic channel mode with “one-click,” according to one embodiment of the present invention. Many other designs with similar functionality are, of course, possible and would be within the scope of the present invention. The remote control 2200 includes a synthetic channel button set 2202 assigned to a set of synthetic channel pages and a buy button 2222. The button set 2202 includes a plurality of buttons which allow a user to access various synthetic channel pages with one click or push of the corresponding buttons.

In particular, the synthetic channel button set includes a sports button 2204 to access a synthetic sports channel page, a shop button 2206 to access a synthetic shopping channel page, an entertain button 2208 to access a synthetic entertainment channel page, a news button 2210 to access a synthetic news channel page, a weather button 2212 to access a synthetic weather channel page, a money button 2214 to access a synthetic money channel page, a music button 2216 to access a synthetic music channel page, and a more button 2220 to access additional synthetic channel pages. These synthetic channel pages include selected TV broadcast channels and Web contents, as described above in connection with FIGS. 13-17.

In one embodiment, the synthetic channel button set 2202 is assigned to a plurality of sets of synthetic channel pages for a plurality of users of the display system. Generally, in a household, a plurality of users view and interact with the display system. Each user may create his or her own set of synthetic channel pages. In one implementation, the set top box 108 stores the plurality of sets of synthetic channel pages and activates an appropriate set according to the selection made on the user sub-menu 502, identifying the current user. If the selection is not made, the set top box accesses the default set of synthetic channel pages, i.e., the “family user” set when the synthetic channel buttons are pressed. The selection can be made by selecting the “user name” on-screen control from the group of primary control 302 and the user submenu 502 in sequence. Alternatively, the remote control be provided with a “hot” button (not shown) that is dedicated to selecting the current user. Each time the “hot” button is pressed a different user is identified. When a desired user is identified, another button may be pressed to select that user.

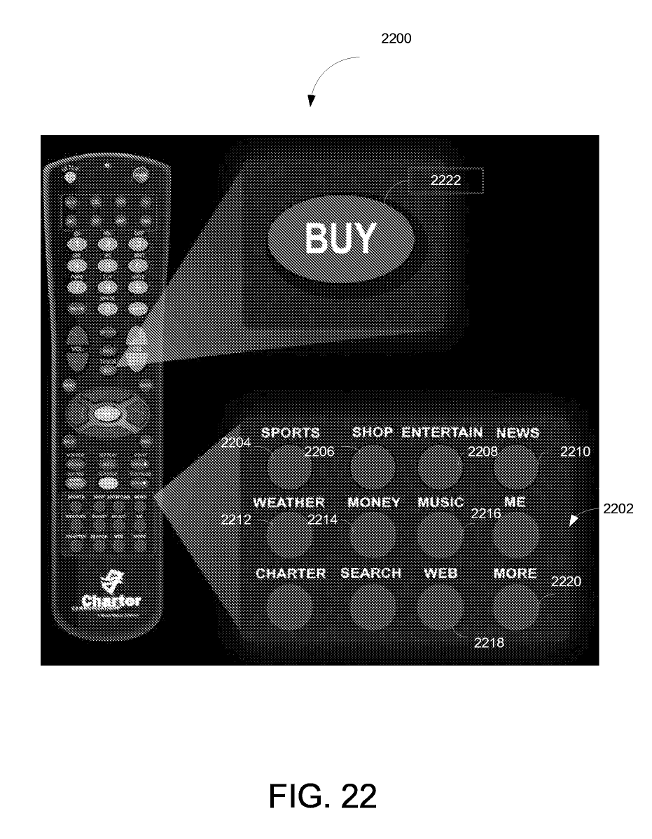

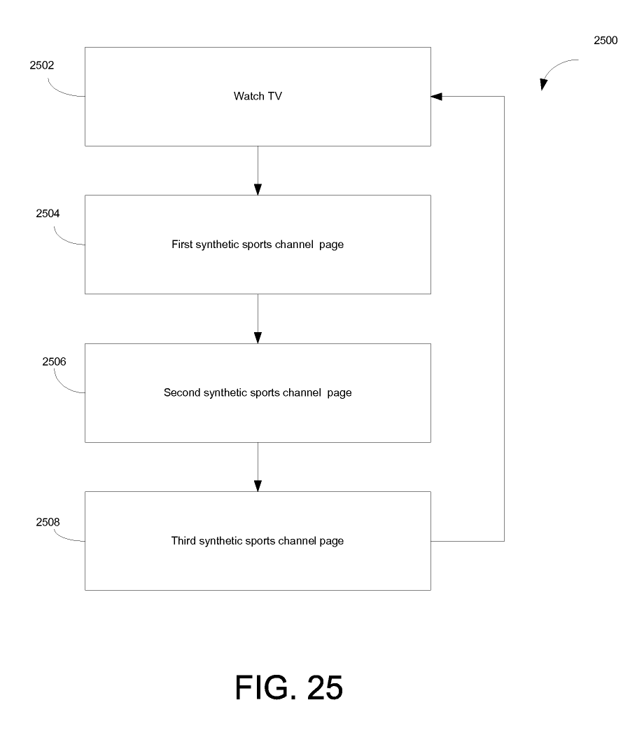

FIGS. 23-25 depicts exemplary methods of navigating between a television content (i.e., TV mode) and a synthetic channel page (e.g., synthetic sports channel page), according to one embodiment of the present invention. Methods of navigating between the television content and other synthetic channel pages would be substantially the same as described herein below for the synthetic sports channel page.

In one embodiment, the sports button 2204 and a GoTo TV button 1103 are used together to navigate between the TV mode and the synthetic sports channel page (FIG. 23). Under a method 2300, the display screen is initially in a TV mode (step 2302). A user presses the sports button 2204 to access a synthetic sports channel page (step 2304). The display screen displays the synthetic sports channel page accordingly (step 2306). The user presses a GoTo TV button to return to the TV mode (step 2308). The display screen displays a television content accordingly (step 2310). The sports button 2204 may be pressed to access the synthetic sports channel page from any mode including while viewing another synthetic channel page.

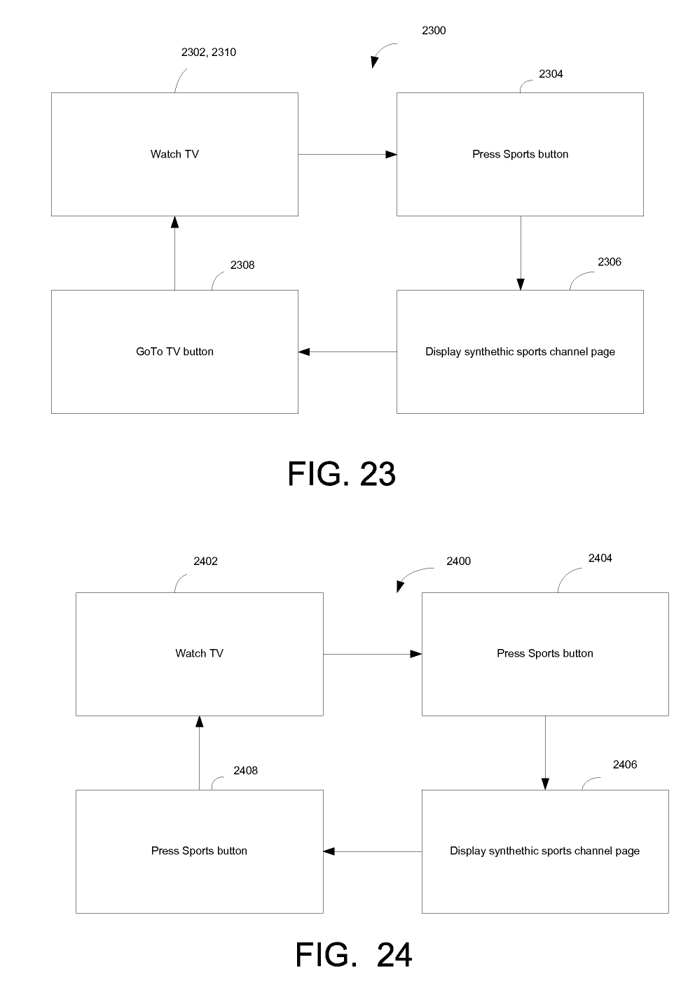

In another embodiment, the sports button 2204 alone may be used to navigate between the TV mode and the synthetic sports channel page (FIG. 24). Under a method 2400, the display screen is initially in a TV mode (step 2402). The user presses the sports button 2204 to access a synthetic sports channel page (step 2404). The display screen displays the synthetic sports channel page accordingly (step 2406). The user presses the sports button again to return to the TV mode (step 2408). The display screen displays a television content accordingly (step 2410). The sports button 2204 may be pressed to access the synthetic sports channel page from any mode including while viewing another synthetic channel page, e.g., a synthetic news channel page, in which case the sports button may serve as a toggle button between the synthetic sports channel page and the synthetic news channel page.

In another embodiment, a plurality of sets of the synthetic channel pages are provided for a plurality of users in a household, where each user is provided with one set of synthetic channel pages. According to an exemplary method 2500, the sports button 2204 can be used sequentially access synthetic sports channel pages of different users in the household. A user 2 is initially watching a television content (step 2502). The sports button 2204 is pressed to access a first synthetic sports channel page (2504). In this illustrative example, it is assumed that the user did not properly log on as a current user using the user submenu 502 on the UI or “hot” button on the remote control. Therefore, the first synthetic sports channel page displayed is the default synthetic sports channel page. If the user 2 had properly logged on, the user 2's own synthetic sports channel page would have appeared as the first synthetic sports page.

Returning to the method 2500, if the sports button 2204 is pressed again, a second synthetic sports channel page is accessed, i.e., the synthetic sports channel page of a user 1 (step 2506). If the sports button is pressed once again, a third synthetic sports channel is accessed, i.e., the synthetic sports channel of the user 2 (step 2508). Thereafter, the user 2 returns to watching the television content. This may be done by pressing the GoTo TV button 1103 or pressing the sports button 2204 again.

In one implementation, the users may protect their synthetic channel pages with a password in order to prevent unauthorized person from accessing their synthetic channel pages. For example, the user 1 is a father of user 2 who is a minor. The user 1 may have included in his synthetic sports channel page a link to adult content sports, such as mud wrestling events. If the user 1 had provided his synthetic sports channel page with a password protection, at step 2506, a prompt requiring the user to enter a password would be displayed. The second synthetic sports channel page would not be displayed unless a correct password is entered. The user 2 can move on the third synthetic sports channel page by pressing the sports button again.

In another implementation, a user may create a plurality of synthetic sports channel pages. For example, the user may create a first synthetic sports channel page dedicated to football, a second synthetic sports channel page dedicated to a particular football team, and a third synthetic sports channel page dedicated a particular athlete. Alternatively, the first, second, and third synthetic sports channel pages can be dedicated to football, soccer, and basketball, respectively. These first, second, and third synthetic sports channels can be accessed by sequentially pressing the sports button 2204, as explained in the exemplary method 2500.

In one embodiment, a single button (e.g. the more button 2220) may be used to access a plurality of different synthetic channel pages on sports, entertainment, news, shopping, and the like. For example, as in the method 2500, the button can be pressed sequentially to access a first synthetic channel page on news, a second synthetic page on sports, a third synthetic channel page on music, and so on. The same button or the GoTo TV button 1103 may used to return to the TV mode.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A method of displaying multimedia contents on a display area of a broadband Internet-enabled television system, the method comprising:
providing a remote control to control contents being displayed on the display area;
displaying a television content on the display area;
receiving a first instruction transmitted by the remote control in response to activation of a first button; and
displaying a first synthetic channel page in response to the first instruction, the first synthetic channel page including a television content section and an Internet content section.

2. The method of claim 1, further comprising:
receiving a second instruction transmitted by the remote control in response to activation of a second button; and
displaying a television content in response to the second instruction.

3. The method of claim 1, further comprising:
receiving a second instruction transmitted by the remote control in response to activation of the first button; and
displaying a television content in response to the second instruction.

4. The method of claim 1, wherein the first synthetic channel page relates to a first subject and the television and Internet content sections display contents relating to the first subject.

5. The method of claim 4, wherein the television content section includes an active channel icon providing a link to a television channel that is currently broadcasting television content relating to the first subject.

6. The method of claim 5, wherein the television content section includes a plurality of active channel icons providing a plurality of links to a plurality of television channels that are currently broadcasting television contents relating to the first subject.

7. The method of claim 6, wherein the plurality of active channel icons display multiple broadcasts from the plurality of television channels in reduced size to enable a user to view the multiple broadcasts simultaneously.

8. The method of claim 6, further comprising:
selecting one of the plurality of active channel icons to view a television content being broadcast by a television station corresponding to the selected channel icon.

9. The method of claim 1, wherein the first synthetic channel page includes an active channel section which lists a plurality of television channels broadcasting contents relating to the first subject.

10. The method of claim 9, wherein the first synthetic channel page further includes a schedule section which lists upcoming events relating to the first subjects

11. The method of claim 10, wherein a user selects one of events listed in the schedule section, further comprising:
receiving a purchase instruction transmitted by the remote control in response to activation of a buy button by the user; and
selling a ticket to the user in response to the purchase instruction.

12. The method of claim 9, wherein the first synthetic channel page further includes a recorded video section which provides a plurality of pre-recorded video contents that can be viewed by a user on the display area.

13. The method of claim 12, wherein a user selects one of the pre-recorded video contents, further comprising:
retrieving the selected pre-recorded video content; and
displaying the retrieved pre-recorded video content on the display area.

14. The method of claim 13, further comprising:
providing the user with an invoice for displaying the retrieved pre-recorded video content on the display area.

15. The method of claim 1, further comprising:
receiving a second instruction transmitted by the remote control in response to activation of the first button; and
displaying a second synthetic channel page in response to the second instruction, the second synthetic channel page including a television content section and an Internet content section relating to a second subject.

16. The method of claim 15, wherein the first synthetic channel page relates to sports, and the second synthetic channel page relates to football.

17. The method of claim 15, wherein the first synthetic channel page relates to football, and the second synthetic channel page relates to Seattle Seahawks.

18. The method of claim 15, wherein the first synthetic channel page relates to sports, and the second synthetic channel page relates to movies.

19. The method of claim 1, wherein the first synthetic channel page is one selected from the following group: sports, weather, music, entertainment, movies, and news.

20. A method of displaying multi-media contents on a display area of a broadband Internet-enabled television system, the method comprising:
providing a remote control to control contents being displayed on the display area;
displaying a first content of first type on the display area;
receiving a first instruction transmitted by the remote control in response to activation of a first button; and
displaying a second content of second type on the display area in response to the first instruction, wherein at least the first content of first type or the second content of second type is a synthetic channel page on a first subject, the synthetic channel page including a television content relating to the first subject and an Internet content relating to the first subject.

21. The method of claim 20, wherein the first content of first type is a user interface menu.

22. The method of claim 20, wherein the first content of first type is the synthetic channel page on the first subject and the second content of second type is a synthetic channel page on a second subject, the synthetic channel page on the second subject including a television content relating to the second subject and an Internet content relating the second subject.

23. The method of claim 20, wherein the first content of first type is a television content.

24. The method of claim 23, further comprising:
receiving a second instruction transmitted by the remote control in response to activation of a second button; and
display the first content of first type on the display area in response to the second instruction.

25. The method of claim 23, further comprising:
receiving a second instruction transmitted by the remote control in response to activation of the first button; and
display the first content of first type on the display area in response to the second instruction.

26. The method of claim 20, further comprising:
displaying a third content of third type on the display area in response to the first instruction, wherein the second content is the synthetic channel page on the first subject, and the third content of third type is a synthetic channel page on a second subject, the synthetic channel page on the second subject having a television content and an Internet content relating to the second subject.

27. The method of claim 26, wherein the second content and the third content are displayed together on the display area.

28. The method of claim 27, wherein the first content of first type is a synthetic channel page on a third subject, the synthetic channel page on the third subject having a television content and an Internet content relating to the third subject.

29. The method of claim 27, wherein the first content of first type is the only synthetic channel page displayed on the display area.

30. A method of displaying multi-media contents on a display area of a broadband Internet-enabled television system, the method comprising:
providing a remote control to control contents being displayed on the display area;
displaying a first content of first type on the display area;
receiving a first instruction transmitted by the remote control in response to activation of a first button; and
displaying a second content of second type on the display area in response to the first instruction,
wherein at least the first content of first type or the second content of second type is a synthetic channel page on a first subject, the synthetic channel page including a plurality of active channel icons displaying a plurality of reduced-sized video contents being broadcast by a plurality of television channels and an Internet content, the plurality of video contents and the Internet content relating to a first subject.

31. The method of claim 30, wherein one or more of the plurality of active channel icons can be selected to display the video content of the selected active channel icon in a non-reduced size on the display area.

32. The method of claim 31, further comprising:
displaying one of the plurality of reduced-sized video contents displayed on the synthetic channel page in the non-reduced size upon the user's selection the corresponding active channel icon.

33. The method of claim 30, wherein the synthetic channel page includes a recorded video icon that can be selected to display a pre-recorded video content in the non-reduced size on the display area, the pre-recorded video content relating to the first subject.

34. The method of claim 33, wherein the pre-recorded video content is stored at a remote server.

35. The method of claim 33, wherein the pre-recorded video content is stored locally in a set top box or a television.

36. The method of claim 30, wherein one or more contents displayed on the synthetic channel page is based on a preference indicated by the user.

37. The method of claim 37, wherein one or more contents displayed on the synthetic channel page is not based on a preference indicated by the user.
